(19) United States
(12) Patent Application Publication
(10) Pub. No.: US 2019/0265555 A1
(43) Pub. Date: Aug. 29, 2019

(54) PANEL MANUFACTURING DEVICE

(71) Applicants: HKC Corporation Limited, Shenzhen (CN); Chongqing HKC Optoelectronics Technology Co., Ltd., Chongqing (CN)

(72) Inventor: CHUN-CHIN HUANG, Chongqing (CN)

(21) Appl. No.: 16/341,449

(22) PCT Filed: Apr. 20, 2017
(86) PCT No.: PCT/CN2017/081222

§ 371 Date: Apr. 12, 2019

(30) Foreign Application Priority Data
Dec. 20, 2016 (CN) 201611183738.1

(51) Int. Cl. G02F 1/1337; G02F 1/13; G02F 1/1333

(52) U.S. Cl. CPC G02F 1/133788; G02F 2001/1316; G02F 1/133351; G02F 1/1303

(57) ABSTRACT

The present application discloses a panel manufacturing device which includes a veneer cutting machine adapted to cutting a substrate, an alignment ultraviolet lighting machine adapted to performing ultraviolet irradiation alignment on the substrate sent by the veneer cutting machine, and an air knife erected at the discharge port of the veneer cutting machine, adapted to cleaning foreign matter on the substrate sent by the veneer cutting machine.

This application claims priority to Chinese Patent Application No. CN2016111837381, filed with the Chinese Patent Office on Dec. 20, 2016 and entitled “PANEL MANUFACTURING DEVICE”, which is incorporated herein by reference in its entirety.

### TECHNICAL FIELD

The present application relates to the technical field of panel manufacturing, and more particularly to a panel manufacturing device.

### BACKGROUND

The description herein provides only background information related to this application, but does not necessarily constitute the existing technology.

Liquid crystal displays have numerous advantages, such as a thin body, power savings, no radiation, etc. and are widely used. Most liquid crystal displays are backlight liquid crystal displays, each including a liquid crystal panel and a backlight module. Working principle of the liquid crystal panel is that liquid crystals are put in two parallel glass substrates, and a driving voltage is applied to the two glass substrates to control rotation of the liquid crystals, to refract light rays of the backlight module to generate a picture.

Thin film transistor-liquid crystal displays (TFT-LCDs) currently maintain a leading status in the display field because of low power consumption, excellent picture quality, high production yield, and other properties. Similarly, the TFT-LCD includes a liquid crystal panel and a backlight module. The liquid crystal panel includes a color filter (CF) substrate, a thin film transistor (TFT) substrate, and transparent electrodes exist on respective inner sides of the above substrates. A layer of liquid crystals (LCs) is positioned between two substrates.

Liquid crystal display panels are widely used in liquid crystal TVs, liquid crystal displays, and other electronic devices. In present manufacturing of liquid crystal display panels, a whole substrate is cut to obtain a plurality of liquid crystal display panels. For the whole substrate, HVA optical alignment is required to be performed, that is, in the case where a voltage is applied to the substrate, monomers in the panel are prompted to react by ultraviolet (UV) irradiation, thereby achieving liquid crystal alignment.

However, the circumstance of low yield often occurs in the course of alignment.

### SUMMARY

The present application provides a panel manufacturing device which can improve product feeling and yield.

To achieve the above purpose, the present application provides a panel manufacturing device which includes: a veneer cutting machine adapted to cutting a substrate; an alignment ultraviolet lighting machine adapted to performing ultraviolet irradiation alignment on the substrate sent by the veneer cutting machine; and an air knife erected at the discharge port of the veneer cutting machine and adapted to cleaning foreign matter on the substrate sent by the veneer cutting machine.

Optionally, the panel manufacturing device further includes a manufacturing platform adapted to bearing the substrate to send the substrate obtained by cutting by an edge veneer cutting machine to the ultraviolet lighting machine, where the air knife is arranged cooperatively with the manufacturing platform.

Optionally, the air knife is arranged on the side surface or upper surface of the manufacturing platform; and an air outlet of the air knife faces the manufacturing platform.

Optionally, the panel manufacturing device further includes a moveable track cooperating with the manufacturing platform, where the air knife is erected at the moveable track, and the air outlet of the air knife faces the manufacturing platform.

Optionally, the manufacturing platform includes a conveying apparatus adapted to bearing the substrate, and an installation apparatus adapted to supporting the conveying apparatus, where the air knife is erected at the installation apparatus, and the air outlet of the air knife faces the conveying apparatus.

Optionally, the panel manufacturing device further includes a moveable track cooperating with the manufacturing platform, where a platform for automatically measuring ultraviolet irradiation intensity arranged cooperatively with the manufacturing platform and adapted to automatically measuring ultraviolet irradiation intensity is erected on the moveable track; and the air knife is erected at the platform for automatically measuring ultraviolet irradiation intensity to perform foreign matter processing on the substrate sent by the veneer cutting machine.

Optionally, the air knife is arranged on the side surface of the platform for automatically measuring ultraviolet irradiation intensity facing the manufacturing platform; and the air outlet of the air knife faces the manufacturing platform.

Optionally, the panel manufacturing device includes a clean dried air supply module, where an air supply end of the air knife is connected to the clean dried air supply module; and length of the air knife is greater than width of the manufacturing platform.

Optionally, the manufacturing platform is adapted to bearing the substrate; the manufacturing platform and the platform for automatically measuring ultraviolet irradiation intensity are arranged between at least two sets of alignment ultraviolet lighting machines; and the alignment ultraviolet lighting machine includes a temperature control platform adapted to performing temperature control on the manufacturing platform when the manufacturing platform is within the range of irradiation of the alignment ultraviolet lighting machine.

Optionally, the panel manufacturing device further includes a loader adapted to feeding substrate material of substrates; a lifting apparatus arranged between the loader and the veneer cutting machine; and a delivery apparatus and a turnover apparatus arranged between the veneer cutting machine and the alignment ultraviolet lighting machine in sequence; where four sets of alignment ultraviolet lighting machines are arranged, and a movable track is arranged within the range of irradiation of the four sets of alignment ultraviolet lighting machines; the movable track is cooperatively provided with a manufacturing platform, a platform for automatically measuring ultraviolet irradiation intensity is also erected on the movable track, the side of the platform for automatically measuring ultraviolet irradiation intensity facing the manufacturing platform is provided with an air knife, and an air outlet of the air knife faces the manufacturing platform; and the alignment ultraviolet lighting machine further includes a temperature control platform adapted to performing temperature control on the manufacturing platform.

The present application also discloses a panel manufacturing device, including: a veneer cutting machine adapted to cutting a substrate; an alignment ultraviolet lighting machine adapted to performing ultraviolet irradiation alignment on the substrate sent by the veneer cutting machine; and an air knife erected at the discharge port of the veneer cutting machine and adapted to cleaning foreign matter on the substrate sent by the veneer cutting machine; the panel manufacturing device further includes a manufacturing platform adapted to bearing the substrate to send the substrate obtained by cutting by an edge veneer cutting machine to the ultraviolet lighting machine, where the air knife is arranged cooperatively with the manufacturing platform; a platform for automatically measuring ultraviolet irradiation intensity arranged cooperatively with the manufacturing platform and adapted to automatically measuring ultraviolet irradiation intensity, is erected on the moveable track, the air knife is erected at the platform for automatically measuring ultraviolet irradiation intensity to perform foreign matter processing on the substrate sent by the veneer cutting machine; the air knife is arranged on the side surface of the platform for automatically measuring ultraviolet irradiation intensity facing the manufacturing platform; an air outlet of the air knife faces the manufacturing platform; the panel manufacturing device further includes a clean dried air supply module, where an air supply end of the air knife is connected to the clean dried air supply module; and length of the air knife is greater than width of the manufacturing platform; the manufacturing platform and the platform for automatically measuring ultraviolet irradiation intensity are arranged between at least two sets of alignment ultraviolet lighting machines; the alignment ultraviolet lighting machine further includes a temperature control platform adapted to performing temperature control on the manufacturing platform when the manufacturing platform is within range of irradiation of the alignment ultraviolet lighting machine; the panel manufacturing device further includes a loader adapted to feeding substrate material of substrates; a lifting apparatus arranged between the loader and the veneer cutting machine; and a delivery apparatus and a turnover apparatus arranged between the veneer cutting machine and the alignment ultraviolet lighting machine in sequence.

The present application also discloses a panel manufacturing method, adapted to the panel manufacturing device, the panel manufacturing method including steps:

cutting a substrate using a veneer cutting machine;

cleaning foreign matter on the substrate sent by the veneer cutting machine using an air knife erected at the discharge port of the veneer cutting machine; and

performing ultraviolet irradiation alignment on the substrate sent by the veneer cutting machine using an alignment ultraviolet lighting machine.

Optionally, the panel manufacturing device includes a manufacturing platform adapted to bearing the substrate to send the substrate obtained by cutting by an edge veneer cutting machine to the ultraviolet lighting machine, where the air knife is arranged cooperatively with the manufacturing platform.

Optionally, the air knife is arranged on the side surface or upper surface of the manufacturing platform; and an air outlet of the air knife faces the manufacturing platform.

Optionally, the panel manufacturing device further includes a moveable track cooperating with the manufacturing platform, where the air knife is erected at the moveable track, and the air outlet of the air knife faces the manufacturing platform.

Optionally, the panel manufacturing device further includes a moveable track cooperating with the manufacturing platform, where a platform for automatically measuring ultraviolet irradiation intensity arranged cooperatively with the manufacturing platform and adapted to automatically measuring ultraviolet irradiation intensity is erected on the moveable track; and the air knife is erected at the platform for automatically measuring ultraviolet irradiation intensity to perform foreign matter processing on the substrate sent by the veneer cutting machine.

Optionally, the air knife is arranged on the side surface of the platform for automatically measuring ultraviolet irradiation intensity facing the manufacturing platform; and the air outlet of the air knife faces the manufacturing platform.

Optionally, the panel manufacturing device further includes a clean dried air supply module, where an air supply end of the air knife is connected to the clean dried air supply module; and length of the air knife is greater than width of the manufacturing platform.

Optionally, the manufacturing platform is adapted to bearing the substrate; the manufacturing platform and the platform for automatically measuring ultraviolet irradiation intensity are arranged between at least two sets of alignment ultraviolet lighting machines; and the alignment ultraviolet lighting machine further includes a temperature control platform adapted to performing temperature control on the manufacturing platform when the manufacturing platform is within the range of irradiation of the alignment ultraviolet lighting machine.

Optionally, the panel manufacturing device further includes a loader adapted to feeding substrate material of substrates; a lifting apparatus arranged between the loader and the veneer cutting machine; and a delivery apparatus and a turnover apparatus arranged between the veneer cutting machine and the alignment ultraviolet lighting machine in sequence; where four sets of alignment ultraviolet lighting machines are arranged, and a movable track is arranged within the range of irradiation of the four sets of alignment ultraviolet lighting machines; the movable track is cooperatively provided with a manufacturing platform, a platform for automatically measuring ultraviolet irradiation intensity is also erected on the movable track, an air knife is arranged on the side surface of the platform for automatically measuring ultraviolet irradiation intensity facing the manufacturing platform, and an air outlet of the air knife faces the manufacturing platform; and the alignment ultraviolet lighting machine further includes a temperature control platform adapted to performing temperature control on the manufacturing platform.

In the present application, because the air knife is erected, foreign matter on the substrate obtained by cutting by the veneer cutting machine may be cleaned, so that the substrate can obtain an optional alignment effect, and if foreign matter such as glass debris, dust and the like occur on the substrate, temperature control and irradiation may not be well implemented when alignment is performed, so that the circumstances such as nonuniform temperature, nonuniform local stress, nonuniform irradiation and the like may occur, and these circumstances may affect the final optical performance of the panel, thereby affecting product feeling and yield; moreover, in the case of being used properly, the air knife not only can clean the foreign matter on the substrate, but also can improve the cleanliness of other parts in the entire manufacture process, thereby being beneficial to improving product yield.

Specific embodiments of the present application are disclosed in detail in reference with the subsequent explanation and figures, and the manner in which the principles of the present application may be adopted is indicated. It should be understood the range of the embodiments of the present application is not limited thereto. Within the range of the spirit and clauses of the appended claims, embodiments of the present application include many alterations, modifications and equivalent. Features described and/or shown for one embodiment may be used in one or more other embodiments in the same or similar manner, to combine with features in other embodiments, or replace the features in other embodiments. It should be emphasized that the terms “comprise” and/or “include” used herein specify the existence of features, integers, steps or assemblies, not excluding the existence or addition of one or more other features, integers, steps or assemblies.

### BRIEF DESCRIPTION OF DRAWINGS

The drawings included are used for providing further understanding of embodiments of the present application, constitute part of the description, are used for illustrating implementation manners of the present application, and interprete principles of the present application together with text description. Apparently, the drawings in the following description are merely some embodiments of the present application, and for those ordinary skilled in the art, other drawings can also be obtained according to the drawings without contributing creative labor. In the drawings:

FIG. 1 is a schematic diagram of a panel manufacturing device.

FIG. 2 is a second schematic diagram of a panel manufacturing device.

FIG. 3 is a third schematic diagram of a panel manufacturing device.

FIG. 4 is a fourth schematic diagram of a panel manufacturing device.

FIG. 5 is a fifth schematic diagram of a panel manufacturing device.

FIG. 6 is a composition diagram of a panel manufacturing device of the present application.

FIG. 7 is a flowchart of a panel manufacturing method disclosed in the present application.

### DETAILED DESCRIPTION

To make those of ordinary skill in the art optional understand technical solutions in the present application, the technical solutions in the embodiments of the present application will be clearly and fully described below in combination with the drawings in the embodiments of the present application. Apparently, the described embodiments are merely part of the embodiments of the present application, not all of the embodiments. Based on the embodiments in the present application, all other embodiments obtained by those of ordinary skill in the art without contributing creative labor will belong to the protection scope of the present application.

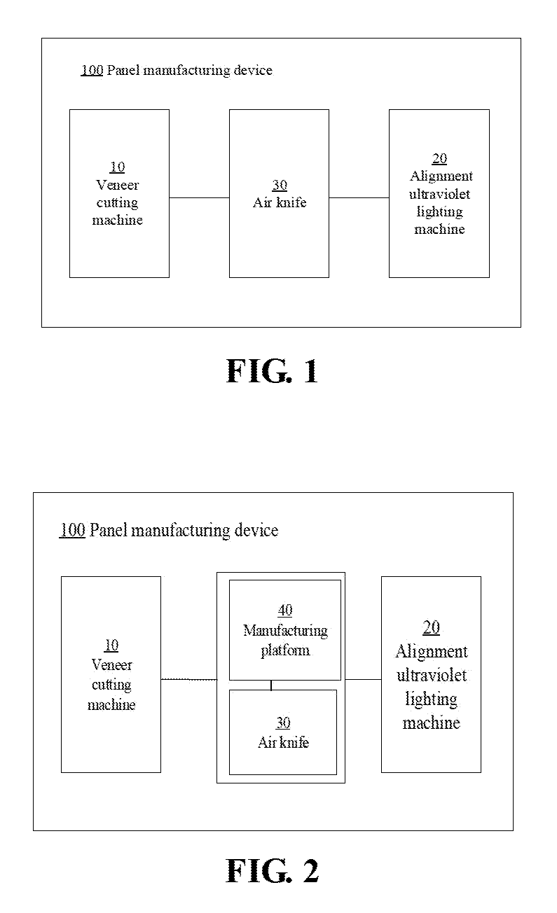

FIG. 1 is a schematic diagram of a panel manufacturing device. See an embodiment shown in FIG. 1, the panel manufacturing device 100 includes: a veneer cutting machine 10 adapted to cutting a substrate; where the substrate may be, for example, a substrate, a plastic substrate or other substrates; an alignment ultraviolet lighting machine 20 adapted to performing ultraviolet irradiation alignment on the substrate sent by the veneer cutting machine 10; and an air knife 30 erected at the discharge port of the veneer cutting machine 10, which is adapted to cleaning foreign matter on the substrate sent by the veneer cutting machine 10, where the air knife may be arranged between the veneer cutting machine and the alignment ultraviolet lighting machine, and may be arranged in the front of the range of irradiation of the alignment ultraviolet lighting machine as well.

In the present application, because the air knife is erected, foreign matter on the substrate obtained by cutting the veneer cutting machine may be cleaned, so that the substrate can have an optional alignment effect, and if foreign matter such as glass debris, dust, and the like occur on the substrate, temperature control and irradiation may not be well implemented when alignment is performed, so that the circumstances such as nonuniform temperature, nonuniform local stress, nonuniform irradiation and the like may occur. These circumstances may affect the final optical performance of the panel, thereby affecting product feeling and yield. Moreover, in the case of being used properly, the air knife not only can clean the foreign matter on the substrate, but also can improve cleanliness of other parts in the entire manufacture process, thereby being beneficial to improving product yield.

FIG. 2 is a second schematic diagram of a panel manufacturing device. See an embodiment shown in FIG. 2, the panel manufacturing device 100 further includes a manufacturing platform 40 adapted to bearing the substrate to send the substrate obtained by cutting by the edge veneer cutting machine 10 to the ultraviolet lighting machine 20; the air knife 30 is arranged cooperatively with the manufacturing platform 40. In this solution, in the course that the substrate arrives or the ultraviolet lighting machine irradiates, the manufacturing platform is adapted to bearing the substrate, and the air knife is arranged cooperatively with the manufacturing platform, so that the air knife can preferably and more conveniently complete clean foreign matter.

In one or more embodiments, the air knife 30 is arranged on the side surface or upper surface of the manufacturing platform 40; an air outlet of the air knife 30 faces the manufacturing platform 40. In this solution, the air knife is arranged cooperatively with the manufacturing platform, and the air knife is arranged on the side surface or upper surface of the manufacturing platform according to the arrangement difference of the manufacturing platform. Of course, the air outlet of the air knife should face the manufacturing platform, so that foreign matter on the substrate thereon can be preferably cleaned, and remaining glass debris, dust and other foreign matter are cleaned through an air knife airflow, thereby improving final optical performance of the product and improving product feel and yield.

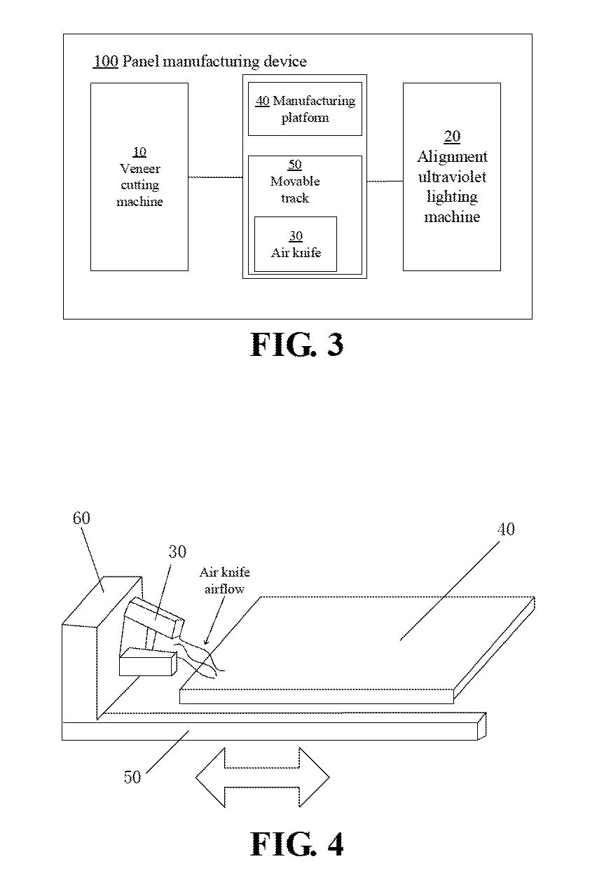

FIG. 3 is a third schematic diagram of a panel manufacturing device. See an embodiment shown in FIG. 3, in one or more embodiments, the panel manufacturing device 100 further includes a movable track 50 cooperating with the manufacturing platform 40; the air knife 30 is erected at the moveable track 50, and the air outlet of the air knife faces the manufacturing platform.

In this solution, a moveable track is presented in the panel manufacturing device in fact and is erected cooperatively with a support platform. Since the air knife is erected at the moveable track, the air knife can move through the moveable track and then aim at the part to be cleaned, to improve cleaning efficiency and effect, thereby being beneficial to improving product feeling and yield. Moreover, since the moveable track is an apparatus which should be presented, cleaning costs can be effectively controlled by means of the apparatus.

In one or more embodiments, the manufacturing platform 40 includes a conveying apparatus (not shown in the figures) adapted to bearing the substrate, and an installation apparatus (not shown in the figures) adapted to supporting the conveying apparatus; the air knife 30 is erected at the installation apparatus, and the air outlet of the air knife 30 faces the conveying apparatus. In this solution, the air knife is fixedly erected at the installation apparatus, so that the air knife not only can clean foreign matter, but also may not affect implementation of other operations of the original manufacturing process.

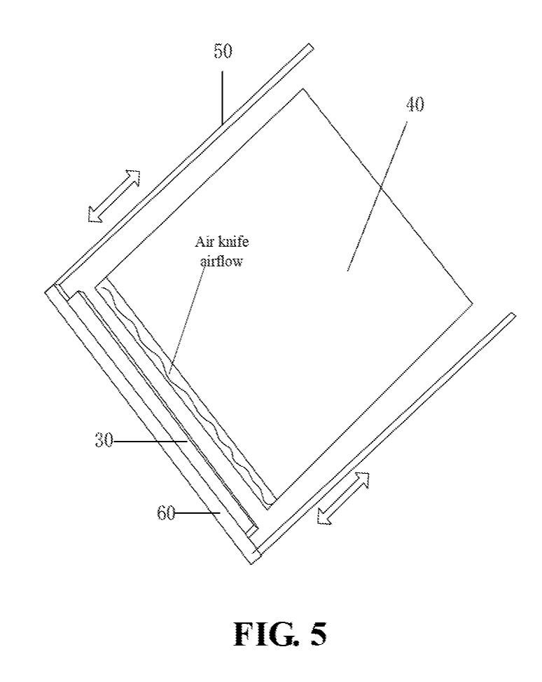

FIG. 4 is a fourth schematic diagram of a panel manufacturing device. FIG. 5 is a fifth schematic diagram of a panel manufacturing device. It can be known from the embodiments shown in FIG. 4 and FIG. 5 that the panel manufacturing device 100 further includes a movable track 50 cooperating with the manufacturing platform 40; a platform 60 for automatically measuring ultraviolet irradiation intensity is arranged cooperatively with the manufacturing platform 40 and is adapted to automatically measuring ultraviolet irradiation intensity is erected on the moveable track 50; the air knife 30 is erected at the platform 60 for automatically measuring ultraviolet irradiation intensity to perform foreign matter processing on the substrate sent by the veneer cutting machine 10.

In this solution, the air knife, and the moveable track and the manufacturing platform are well arranged cooperatively by means of the platform for automatically measuring ultraviolet irradiation intensity. However, because of being arranged to measure the ultraviolet irradiation intensity of the substrate borne by the manufacturing platform, the platform for automatically measuring ultraviolet irradiation intensity can preferably cover the substrate correspondingly, and since the air knife cooperates with the platform for automatically measuring ultraviolet irradiation intensity, airflow of the air knife can be guaranteed to pervade everywhere of the substrate, thereby avoiding the situation where one part of foreign matter on the substrate are cleaned while other parts of foreign matter are not cleaned.

In one or more embodiments, the air knife 30 is arranged on the side surface of the platform 60 for automatically measuring ultraviolet irradiation intensity facing the manufacturing platform. an air outlet of the air knife 30 faces the manufacturing platform 40. In this solution, the air knife is well erected on the side surface of the platform for automatically measuring ultraviolet irradiation intensity facing the manufacturing platform, so that the air outlet of the air knife can be well aligned with the manufacturing platform. Therefore, when the substrate passes, the air knife can well complete the work of cleaning foreign matter on the substrate, thereby preferably controlling the temperature uniformity of the pre-aligned substrate in the course of irradiating the substrate by the alignment ultraviolet lighting machine, which may improve final optical performance of the panel and improving product feel and yield.

In one or more embodiments, the panel manufacturing device 100 further includes a clean dried air (CDA) supply module, where an air supply end of the air knife 30 is connected to the clean dried air supply module, and the length of the air knife 30 is greater than the width of the manufacturing platform 40. In this solution, the air knife uses the clean dried air (CDA) supply module to supply air so that the cleanliness of the supplied air is guaranteed and is more controllable, and cooperates with the platform for automatically measuring ultraviolet irradiation intensity to control the moving period and frequency thereof, thereby controlling the cleaning frequency in the manufacture course. Length of the air knife, especially the length of a corresponding air outlet, is slightly greater than the width of the manufacturing platform, and since the side surface of the substrate corresponding to the manufacturing platform in width is a main “severely afflicted area” where glass debris may occur, foreign matter on the substrate is more effectively cleaned by such setting, thereby improving final product feel and yield. Moreover, the clean dried air (CDA) supply module is fully used, thereby achieving the purpose of killing two birds with one stone.

In one or more embodiments, the panel manufacturing device 100 further includes the manufacturing platform 40 adapted to bearing the substrate; the manufacturing platform 40 and the platform 60 for automatically measuring ultraviolet irradiation intensity are arranged between at least two sets of alignment ultraviolet lighting machines 20; the alignment ultraviolet lighting machine 20 further includes a temperature control platform (not shown in the figures) adapted to performing temperature control on the manufacturing platform 40 when the manufacturing platform 40 is within the range of irradiation of the alignment ultraviolet lighting machine 20. In this solution, when the alignment ultraviolet lighting machine processes the pre-aligned substrate, in fact, the temperature of the manufacturing platform and the temperature of the substrate are controlled by the temperature control platform, and whether the temperature is well controlled may affect the final optical performance of the panel to a great extent, where remaining glass debris may occur, of course, dust and the like may also occur on the substrate obtained by cutting by the veneer cutting machine, the temperature control platform may not well realize temperature control and if these things are not completely stripped, and final optical performance of the panel may be poor if the circumstances such as nonuniform local temperature, nonuniform local stress, nonuniform local irradiation and the like occur to the substrate, thereby affecting product feeling and yield. But here, these circumstances may be solved by good cooperation among the moveable track, the manufacturing platform, the platform for automatically measuring ultraviolet irradiation intensity, the alignment ultraviolet lighting machine and the temperature control platform therein.

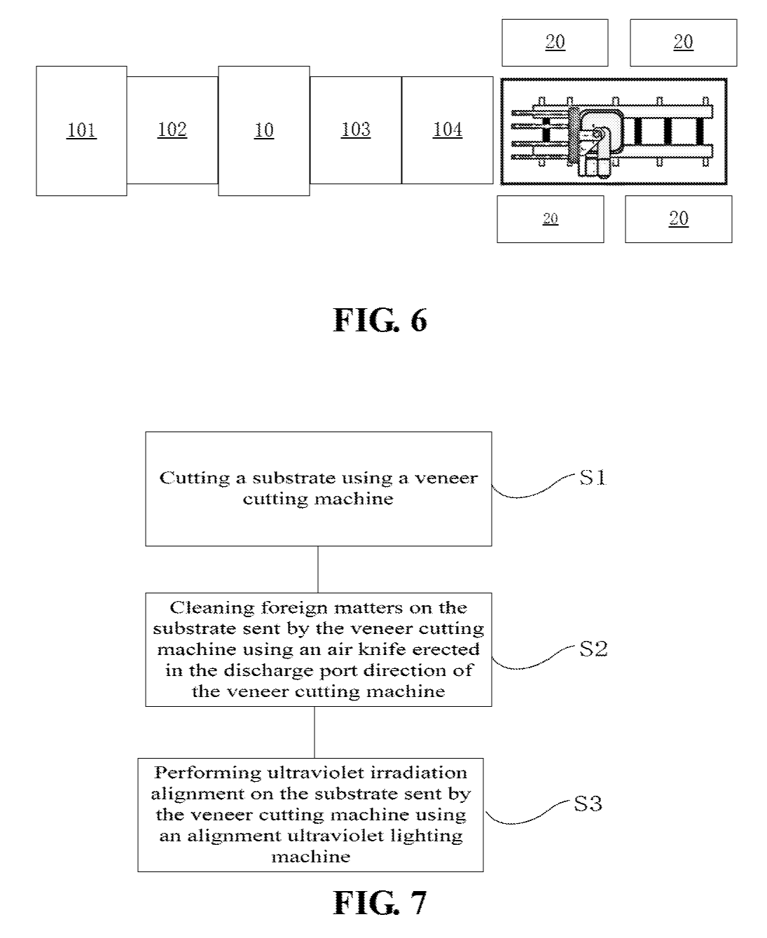

FIG. 6 is a composition diagram of a panel manufacturing device of the present application. It can be known from the embodiment shown in FIG. 6 that in one or more embodiments, preferably, the panel manufacturing device 100 further includes a loader 101 adapted to feeding substrate material of substrates; a lifting apparatus 102 arranged between the loader 101 and the veneer cutting machine 10; a delivery apparatus 103 and a turnover apparatus 104 arranged between the veneer cutting machine 10 and the alignment ultraviolet lighting machine 20 in sequence, where four sets of alignment ultraviolet lighting machines 20 are arranged, and a movable track 50 is arranged within the range of irradiation of the four sets of alignment ultraviolet lighting machines 20; the movable track 50 is cooperatively provided with a manufacturing platform 40, a platform 60 for automatically measuring ultraviolet irradiation intensity is also erected on the movable track 50, and an air knife 30 is arranged on the side surface of the platform 60 for automatically measuring ultraviolet irradiation intensity facing the manufacturing platform 40, an air outlet of the air knife 30 facing the manufacturing platform 40; the alignment ultraviolet lighting machine 20 further includes a temperature control platform adapted to performing temperature control on the manufacturing platform 40. In this solution, the correlation between panel manufacturing devices is substantially introduced. The main reason for cleaning foreign matter on the substrate is that glass debris may remain on the substrate after the veneer cutting machine completes the work, other parts may be contaminated by dust and other foreign matter in the entire manufacture course, and adverse effects may be brought if theses foreign matter are not cleaned; thus, the air knife can clean the foreign matter on the substrate before or when the alignment ultraviolet lighting machine processes to improve the effects in the subsequent course of temperature control and alignment ultraviolet irradiation, thereby improving product feel and yield.

FIG. 7 is a flowchart of a panel manufacturing method disclosed in the present application. It can be known from the embodiment shown in FIG. 7 in combination with FIG. 1 to FIG. 6 that the method includes the steps:

S1: cutting a substrate using a veneer cutting machine;

S2: cleaning foreign matter on the substrate sent by the veneer cutting machine using an air knife erected at the discharge port of the veneer cutting machine; and

S3: performing ultraviolet irradiation alignment on the substrate sent by the veneer cutting machine using an alignment ultraviolet lighting machine.

This method is suitable for the above-mentioned panel manufacturing device. The present application has the beneficial effects that in the manufacture process of the present application, because the air knife is erected at the discharge port of the veneer cutting machine, foreign matter on the substrate obtained by cutting by the veneer cutting machine may be cleaned, so that the substrate can obtain a preferable alignment effect, and if foreign matter such as glass debris, dust and the like occur on the substrate, temperature control and irradiation may not be well implemented when alignment is performed, so that the circumstances such as nonuniform temperature, nonuniform local stress, nonuniform irradiation and the like may occur, and these circumstances may affect the final optical performance of the panel, thereby affecting product feeling and yield; moreover, in the case of being used properly, the air knife not only can clean the foreign matter on the substrate, but also can improve the cleanliness of other parts in the entire manufacture process, thereby being beneficial to improving product yield.

Specific optional embodiments of the present application are described above in detail. It should be understood that those of ordinary skill in the art can make various modifications and alterations in accordance with the concepts of the present application without contributing creative labor. Therefore, all technical solutions obtained by those of ordinary skill in the art through logical analysis, reasoning or limited experiments in accordance with the concepts of the present application on the basis of the prior art should be within the protection range determined by the claims.

What is claimed is:

1. A panel manufacturing device, comprising:
a veneer cutting machine adapted to cutting a substrate;
an alignment ultraviolet lighting machine adapted to performing ultraviolet irradiation alignment on the substrate sent by the veneer cutting machine; and
an air knife erected at the discharge port of the veneer cutting machine and adapted to cleaning foreign matter on the substrate sent by the veneer cutting machine: the panel manufacturing device further comprises a manufacturing platform adapted to bearing the substrate to send the substrate obtained by cutting by an edge veneer cutting machine to the ultraviolet lighting machine, wherein the air knife is arranged cooperatively with the manufacturing platform;
a platform for automatically measuring ultraviolet irradiation intensity arranged cooperatively with the manufacturing platform and adapted to automatically measuring ultraviolet irradiation intensity, is erected on the moveable track; the air knife is erected at the platform for automatically measuring ultraviolet irradiation intensity to perform foreign matter processing on the substrate sent by the veneer cutting machine; the air knife is arranged on the side surface of the platform for automatically measuring ultraviolet irradiation intensity facing the manufacturing platform; an air outlet of the air knife faces the manufacturing platform; the panel manufacturing device farther comprises a clean dried air supply module, wherein an air supply end of the air knife is connected to the clean dried air supply module; and length of the air knife is greater than width of the manufacturing platform;
the manufacturing platform and the platform for automatically measuring ultraviolet irradiation intensity are arranged between at least two sets of alignment ultraviolet lighting machines: the alignment ultraviolet lighting machine further comprises a temperature control platform adapted to performing temperature control on the manufacturing platform when the manufacturing platform is within range of irradiation of the alignment ultraviolet lighting machine;
the panel manufacturing device further comprises a loader adapted to feeding substrate material of substrates; a lifting apparatus arranged between the loader and the veneer cutting machine; and a delivery apparatus and a turnover apparatus arranged between the veneer cutting machine and the alignment ultraviolet lighting machine in sequence.

2. A panel manufacturing device, comprising:
a veneer cutting machine adapted to cutting a substrate;
an alignment ultraviolet lighting machine adapted to performing ultraviolet irradiation alignment on the substrate sent by the veneer cutting machine; and
an air knife erected at the discharge port of the veneer cutting machine and adapted to cleaning foreign matter on the substrate sent by the veneer cutting machine.

3. The panel manufacturing device according to claim 2, wherein the panel manufacturing device further comprises a manufacturing platform adapted to bearing the substrate to send the substrate obtained by cutting by an edge veneer cutting machine to the ultraviolet lighting machine;
wherein the air knife is arranged cooperatively with the manufacturing platform.

4. The panel manufacturing device according to claim 3, wherein the air knife is arranged on the side surface or upper surface of the manufacturing platform; and
an air outlet of the air knife faces the manufacturing platform.

5. The panel manufacturing device according to claim 3, wherein the panel manufacturing device further comprises a moveable track cooperating with the manufacturing platform;
wherein the air knife is erected at the moveable track, and the air outlet of the air knife faces the manufacturing platform.

6. The panel manufacturing device according to claim 3, wherein the manufacturing platform comprises a conveying apparatus adapted to bearing the substrate, and an installation apparatus adapted to supporting the conveying apparatus;
wherein the air knife is erected at the installation apparatus, and the air outlet of the air knife faces the conveying apparatus.

7. The panel manufacturing device according to claim 3, wherein the panel manufacturing device further comprises a moveable track cooperating with the manufacturing platform;
wherein a platform for automatically measuring ultraviolet irradiation intensity arranged cooperatively with the manufacturing platform and adapted to automatically measuring ultraviolet irradiation intensity is erected on the moveable track; and
the air knife is erected at the platform for automatically measuring ultraviolet irradiation intensity to perform foreign matter processing on the substrate sent by the veneer cutting machine.

8. The panel manufacturing device according to claim 7, wherein the air knife is arranged on the side surface of the platform for automatically measuring ultraviolet irradiation intensity facing the manufacturing platform; and
the air outlet of the air knife faces the manufacturing platform.

9. The panel manufacturing device according to claim 7, wherein the panel manufacturing device comprises a clean dried air supply module, wherein an air supply end of the air knife is connected to the clean dried air supply module; and
length of the air knife is greater than width of the manufacturing platform.

10. The panel manufacturing device according to claim 7, wherein the manufacturing platform is adapted to bearing the substrate;
the manufacturing platform and the platform for automatically measuring ultraviolet irradiation intensity are arranged between at least two sets of alignment ultraviolet lighting machines; and
the alignment ultraviolet lighting machine comprises a temperature control platform adapted to performing temperature control on the manufacturing platform when the manufacturing platform is within the range of irradiation of the alignment ultraviolet lighting machine.

11. The panel manufacturing device according to claim 2, wherein the panel manufacturing device further comprises a loader adapted to feeding substrate material of substrates;
a lifting apparatus arranged between the loader and the veneer cutting machine; and
a delivery apparatus and a turnover apparatus arranged between the veneer cutting machine and the alignment ultraviolet lighting machine in sequence;
wherein four sets of alignment ultraviolet lighting machines are arranged, and a movable track is arranged within the range of irradiation of the four sets of alignment ultraviolet lighting machines;
the movable track is cooperatively provided with a manufacturing platform, a platform for automatically measuring ultraviolet irradiation intensity is also erected on the movable track, the side of the platform for automatically measuring ultraviolet irradiation intensity facing the manufacturing platform is provided with an air knife, and an air outlet of the air knife faces the manufacturing platform; and
the alignment ultraviolet lighting machine further comprises a temperature control platform adapted to performing temperature control on the manufacturing platform.

12. A panel manufacturing method, adapted to the panel manufacturing device, the panel manufacturing method comprising steps:
cutting a substrate using a veneer cutting machine;
cleaning foreign matter on the substrate sent by the veneer cutting machine using an air knife erected at the discharge port of the veneer cutting machine; and
performing ultraviolet irradiation alignment on the substrate sent by the veneer cutting machine using an alignment ultraviolet lighting machine.

13. The panel manufacturing method according to claim 12, wherein the panel manufacturing device comprises a manufacturing platform adapted to bearing the substrate to send the substrate obtained by cutting by an edge veneer cutting machine to the ultraviolet lighting machine;
wherein the air knife is arranged cooperatively with the manufacturing platform.

14. The panel manufacturing method according to claim 13, wherein the air knife is arranged on the side surface or upper surface of the manufacturing platform; and
an air outlet of the air knife faces the manufacturing platform.

15. The panel manufacturing method according to claim 13, wherein the panel manufacturing device further comprises a moveable track cooperating with the manufacturing platform;
wherein the air knife is erected at the moveable track, and the air outlet of the air knife faces the manufacturing platform.

16. The panel manufacturing method according to claim 13, wherein the panel manufacturing device further comprises a moveable track cooperating with the manufacturing platform;
wherein a platform for automatically measuring ultraviolet irradiation intensity arranged cooperatively with the manufacturing platform and adapted to automatically measuring ultraviolet irradiation intensity is erected on the moveable track; and
the air knife is erected at the platform for automatically measuring ultraviolet irradiation intensity to perform foreign matter processing on the substrate sent by the veneer cutting machine.

17. The panel manufacturing method according to claim 16, wherein the air knife is arranged on the side surface of the platform for automatically measuring ultraviolet irradiation intensity facing the manufacturing platform; and
the air outlet of the air knife faces the manufacturing platform.

18. The panel manufacturing method according to claim 16, wherein the panel manufacturing device further comprises a clean dried air supply module, wherein an air supply end of the air knife is connected to the clean dried air supply module; and
length of the air knife is greater than width of the manufacturing platform.

19. The panel manufacturing method according to claim 16, wherein the manufacturing platform is adapted to bearing the substrate;
the manufacturing platform and the platform for automatically measuring ultraviolet irradiation intensity are arranged between at least two sets of alignment ultraviolet lighting machines; and
the alignment ultraviolet lighting machine further comprises a temperature control platform adapted to performing temperature control on the manufacturing platform when the manufacturing platform is within the range of irradiation of the alignment ultraviolet lighting machine.

20. The panel manufacturing method according to claim 12, wherein the panel manufacturing device further comprises a loader adapted to feeding substrate material of substrates;
a lifting apparatus arranged between the loader and the veneer cutting machine; and
a delivery apparatus and a turnover apparatus arranged between the veneer cutting machine and the alignment ultraviolet lighting machine in sequence;
wherein four sets of alignment ultraviolet lighting machines are arranged, and a movable track is arranged within the range of irradiation of the four sets of alignment ultraviolet lighting machines;
the movable track is cooperatively provided with a manufacturing platform, a platform for automatically measuring ultraviolet irradiation intensity is also erected on the movable track, an air knife is arranged on the side surface of the platform for automatically measuring ultraviolet irradiation intensity facing the manufacturing platform, and an air outlet of the air knife faces the manufacturing platform; and
the alignment ultraviolet lighting machine further comprises a temperature control platform adapted to performing temperature control on the manufacturing platform.
